(19) United States
(12) Patent Application Publication
(10) Pub. No.: US 2016/0137924 A1
(43) Pub. Date: May 19, 2016

(54) PROCESSES FOR HOLDING CHAR IN A CATALYIC FAST PYROLYSIS PROCESS AND CHAR COMPOSITIONS

(71) Applicant: Anellotech, Inc., Pearl River, NY (US)

(72) Inventors: Terry J. Mazanec, Solon, OH (US); Michael Tanzio, Cherry Hill, NJ (US); Charles M. Sorensen, JR., Haverstraw, NY (US); Ruozhi Song, Maple Valley, WA (US); Jian Shi, Pearl River, NY (US); Yu-Ting Cheng, Amherst, MA (US); William F. Igoe, JR., Pearl River, NY (US); Alkis Rappas, Kingwood, TX (US); Sandeep K. Goud, West Hartford, CT (US)

(21) Appl. No.: 14/944,102

(22) Filed: Nov. 17, 2015

Related U.S. Application Data
(60) Provisional application No. 62/080,938, filed on Nov. 17, 2014.

(51) Int. Cl. C10B 53/02; C10B 57/06; A01G 1/00; C10G 1/06

(52) U.S. Cl. CPC C10B 53/02; C10G 1/06; C10B 57/06; A01G 1/001

(57) ABSTRACT

Methods of separating and utilizing char produced by the catalytic fast pyrolysis of biomass are described. In a preferred method, a portion of the char from a catalytic pyrolysis reactor is recovered and treated and combusted to provide heat to the catalytic pyrolysis reactor. A novel char and methods of amending soil with a char composition are also described.

### RELATED APPLICATION

This application claims the priority benefit of U.S. Provisional Patent Application Ser. No. 62/080,938, filed 17 Nov. 2014.

### INTRODUCTION

Obtaining useful chemicals, fuels, and energy from renewable biomass represents an important challenge as conventional fossil sources of these materials are slowly depleted. Lignocellulosic biomass is being studied widely as a viable feedstock for renewable liquid biofuels and chemicals because of its low cost and global availability. Biomass-derived fuels and chemicals are projected to substantially reduce net CO₂ emissions as well, if produced with minimal use of fossil fuels.

To meet this challenge, there have been extensive efforts made to convert biomass to fuels and other useful chemicals. Producing fuels and chemicals from biomass requires specialized conversion processes different from conventional petroleum-based conversion processes due to the nature of the feedstock and products. High temperatures, solid feed, high concentrations of water, high oxygen content in the feed, unusual separations, and oxygenated by-products are some of the features of biomass conversion that are distinct from those encountered in petroleum upgrading. Thus, there are many challenges that must be overcome to efficiently produce chemicals from biomass.

Biomass materials generally comprise lignin, cellulose, and hemi-cellulose as major components, a variety of lesser organic materials, water, and some mineral elements. A range of biomass derived materials can be pyrolyzed to produce mixtures of aromatics, olefins, CO, CO₂, water, char, coke, and other products. A particularly desirable form of pyrolysis is known as catalytic fast pyrolysis (CFP) that involves the conversion of biomass in a catalytic fluid bed reactor to produce a mixture of aromatics, olefins, and a variety of other materials. The aromatics include benzene, toluene, xylenes, (collectively BTX), and naphthalene, among other aromatics. The olefins include ethylene, propylene, and lesser amounts of higher molecular weight olefins. BTX aromatics have high value and are easily transported.

The raw effluent from a CFP process is a complex mixture that comprises aromatics, olefins, oxygenates, paraffins, H₂, CH₄, CO, CO₂, water, char, ash, coke, catalyst fines, and other materials. Separation, recovery, and purification of the various components from this complex mixture present challenges that have not been solved satisfactorily.

A particularly vexing problem is the production of solid char in substantial amounts in the presence of a solid catalyst. Char is a term applied to the carbon rich solid material that has been partially converted in a combustion or pyrolysis process. In the regeneration of a used CFP catalyst, the presence of char increases the size of the regenerator needed and the amount of heat released, increasing costs and potentially damaging the CFP catalyst; thus, separating and removing char provides process and cost advantages. Moreover, the carbon and other materials that are present in char represent a substantial fraction of the value of the biomass feedstock, so methods of recovering that value have been studied.

Chieky et al. in US Patent Application 20140073708 describes a process of converting biomass to products that creates a volatile and a nonvolatile fraction, and the nonvolatile fraction may include char. The volatile fraction can include olefins and fuels such as kerosene, and a fraction may be further processed to increase aromatics.

Stamires and O'Connor in US Patent Application 20140007499 describe a process for making bio-oil in which soft coke that is obtained from a stripper is used to pretreat the biomass feed to the catalytic pyrolysis reactor.

Lissianski et al. in US Patent Application 20120024843 describe a method in which carbonaceous material is heated with microwave energy to generate a mixture comprising char, oil and gas. A separation of the mixture may be carried out in a cyclone that is disposed downstream of the reactor. The separated char may then be conveyed to a heat recovery unit. The heat recovered from the heat recovery unit may then be recycled to a pre-heater. The separated char may be partially combusted and returned to the reactor to supply the heat for the treatment of the carbonaceous material. Alternatively, the char drawn from the heat recovery unit may be further subjected to treatment such as, for example, char gasification. It is also suggested that the char can also be used as a fertilizer—especially when the feedstock is made up of significant amounts of biomass.

Raman et al. in WO/2009/111345 state that biomass char can be generated by providing a biomass particulate to a combustion and/or gasification reactor. Such reactors may be integrated into a catalytic gasification process. For example, in an integrated process, a biomass particulate can be provided to a combustion reactor in contact with a water source for the production of steam; such steam can be provided, in whole or in part, to a catalytic gasification reactor and the biomass char produced therein may be extracted and utilized for the preparation of a particulate composition for the catalytic gasification reactor. The biomass char may be reduced in particle size by quenching a hot biomass char with water, such that the stress induced in the char by the rapid temperature change causes the char to shatter into smaller particles and create a slurry.

Palmas et al. in U.S. Pat. No. 8,499,702 describe a process for pyrolysis of a carbonaceous biomass feedstock that produces pyrolysis products and a spent heat transfer medium. The spent heat transfer medium is separated into segregated char and char-depleted spent heat transfer medium. The segregated char is combusted with a heat transfer medium from the fluidized dense bed in the oxygen-containing regeneration gas outside the reheater. The char-depleted spent heat transfer medium enters the oxygen-containing regeneration gas stream in the reheater under conditions sufficient to combust the residual char. Combustion raises the temperature of the dense bed material (i.e., the heat transfer medium) to the operating conditions needed in the pyrolysis reactor, i.e., about 300° C. to about 900° C.

Jadhav in U.S. Pat. No. 8,404,909 describe a process in which solids including char and heat energy carrier particles including metal oxide sorbents are separated from the gaseous phase and are delivered to the char combustor. A stream of char and reduced heat energy carrier particles is supplied to char combustor. Also, supplied to the char combustor is a supply stream of heat energy carrier particles including oxidized metal oxide sorbents. After combustion of char in the char combustor, a portion of the heated reduced metal oxide sorbents is delivered by stream to an oxidation reactor. A portion of the heat energy carrier particles is received from char combustor and delivered to the pyrolysis reactor, in this manner, heat can be conveyed from the char combustor to the pyrolysis reactor.

Char separation from a catalytic fast pyrolysis process, and its subsequent processing are not established processes in the biomass upgrading industry.

Despite these and other prior efforts, a need remains for improved processes for recovering, separating, and extracting value from the char produced as part of the product effluent of a catalytic pyrolysis process, in order to make the process more energy-efficient, reduce the size and heat duty of the catalyst regenerator, remove minerals with the char, selectively remove catalyst fines generated by attrition, and extend the life of the catalyst.

### SUMMARY OF THE INVENTION

The invention provides improvements to the CFP process and novel char compositions.

In a first aspect, the invention provides a method for producing aromatic chemicals or olefins, comprising: reacting solid biomass in the presence of a catalyst in a reaction zone; producing a product stream or product streams that exits from the reaction zone; withdrawing a solid mixture from the reaction zone; wherein the solid mixture that is removed is separate from the product stream or streams; separating at least a portion of char from the solid mixture prior to a catalyst regeneration step; optionally adding a portion of the separated char to the reaction zone; wherein the char is not mixed in with biomass prior to the reaction zone; and recovering aromatics or olefins from the product mixture.

In some preferred embodiments, aromatics are recovered and the recovered aromatics comprise benzene, toluene, and xylenes in an amount of at least 10%, preferably at least 15%, yield based on carbon in the biomass where the yield is the sum of the carbon in the benzene, toluene, and xylenes divided by the carbon in the biomass feed, multiplied by 100%. In this method, the raw product stream or streams are primarily (by mass) gaseous organic compounds, CO, CO₂, and water, typically greater than 90% or at least 95% gas with minor amounts of entrained solids.

In some preferred embodiments, the inventive method can be further characterized by one or any combination of the following:
wherein the separating is conducted in a cyclone or series of cyclones;
wherein the separating is conducted in a series of cyclones wherein the linear velocity of the materials entering each succeeding cyclone used to separate char is no less than the linear velocity of the materials entering the previous cyclone in the series of cyclones;
wherein char is separated from a catalyst by elutriation;
wherein char is separated from a catalyst and char mixture by solids flotation, preferably comprising a bubbling bed of gas and solid particles;
wherein char is separated from a catalyst and char mixture by a screen, a set of screens with various hole openings, or another size exclusion device where separation of solids occurs based on particle size differences;
wherein at least a portion of the char is comminuted before it is separated from the other solids (this step will make char particles smaller and thus easier to separate char from catalyst);
wherein at least a portion of the char is comminuted in a conveyance pipe, optionally through conveyance pipe a that has a non-uniform internal cross section along its length;
wherein at least a portion of the char is comminuted in a conveyance pipe that comprises a static mixer; at least a portion of the char is comminuted by an impingement surface or device wherein a stream of the particles impact the surface at an angle of attack of at least 45 degrees from the parallel;
wherein a portion of the char is separated from the solids mixture by electrostatic separation;
combustion with an excess of oxygen greater than the minimum required for complete conversion of the char into carbon dioxide and water;
wherein heat is recovered from the combustion of the char and transferred to the catalytic biomass conversion reactor;
wherein heat is recovered from the combustion of the char and utilized to generate steam;
wherein the char combustion process is operated at temperature of at least 700 C, or at least 800 C, or at least 900 C, or at least 1000 C, or from 700 C to 1300 C, or from 800 to 1200 C;
wherein the catalyst comprises a zeolite, and wherein the catalyst regeneration is operated at a temperature of less than 750 C, or less than 700 C, or less than 650 C, or less than 625 C, or from 550 C to 750 C, or from 575 C to 700 C, or from 600 C to 650 C;
wherein the catalyst comprises at least 10 wt % ZSM-5;
wherein the solid mixture withdrawn from the reaction zone is a mixture of catalyst and char, and the catalyst and char mixture is stripped in a steam stripper;
wherein the temperature of the steam stripper may be in the range from 100 to 700 C, or from 250 to 650 C, or from 400 to 625 C, or from 500 to 600 C, or may be at least 100 C, or at least 250 C, or at least 400 C, or at least 500 C, or less than 700 C, or less than 650 C, or less than 600 C;
recovering olefins from the products;
utilizing the char to generate electricity;
wherein at least a portion of the char is chemically reacted and a portion of the reacted char is returned to the catalytic biomass reactor;
wherein at least a portion of the char is oxidized before it is returned to the catalytic biomass reactor (this step is advantageous since the oxidized char results in a higher yield of BTX as compared to the unoxidized char) preferably the ratio of oxygen atoms in the added oxidant to carbon atoms in the char (O/C ratio) is less than 1.5, less than 1.0, less than 0.8, less than 0.5, or less than 0.25, or from 0.01 to 1.5, or from 0.05 to 1.0, or from 0.1 to 0.8, or from 0.15 to 0.5 in the char treatment process;
wherein the char is partially oxidized by reaction with ozone, oxygen, diluted air, hydrogen peroxide, peracetic acid (CH3C(O)OOH), performic acid (HC(O)OOH), isobutyl peroxide, NO2, NO, or other gaseous or liquid oxidizing agents;
wherein in the oxidation of char the oxygen in the oxidant to carbon in the char ratio (O/C ratio) is less than 1.5, less than 1.0, less than 0.8, less than 0.5, or less than 0.25, or from 0.01 to 1.5, or from 0.05 to 1.0, or from 0.1 to 0.8, or from 0.15 to 0.5 in the char treatment process.
wherein the char treatment results in products having an increased oxygen content or a higher O/C ratio as compared to the freshly produced char;
wherein the products of the char treatment show an increased content of carbon to oxygen single and carbon to oxygen double bonds as measured by infrared spectroscopy of the solid, liquid, or both solid and liquid products;
wherein at least a portion of the char is stripped in a steam stripper;
wherein the char is treated with an acidic solution; preferably the acidic solution comprises acetic, formic, nitric, sulfuric, propionic, or carbonic acid, or a portion of the water produced in the CFP process, or combinations of these;
wherein the char is treated with a basic solution; preferably comprising a portion of the water produced in the CFP process, or a wash solution obtained from washing catalysts used in the CFP process, or a solution prepared using ash produced in a CFP process, or combinations of these.

The invention includes a char-based composition (char) produced by any of the methods described herein.

In another aspect, the invention provides a char-based composition (char) comprising at least 1 wt % zeolite or zeolite-containing catalyst and 10 to 99 wt % carbon, preferably the char comprises at least 1 wt % zeolite. In some preferred embodiments, the inventive composition can be further characterized by one or any combination of the following:
the char having acidity such that, if exposed to distilled water the char produces a solution which has a pH less than 7, less than 6, less than 5, or less than 4, or from 2 to 7, or from 2.5 to 6, or from 3 to 5;
wherein the char comprises from 1 to 50% by weight, or from 2 to 40% by weight, or from 5 to 35% by weight, or from 10 to 30% by weight, or from 15 to 25% by weight, or at least 1% by weight, or at least 2% by weight, or at least 5% by weight, or at least 10% by weight, or at least 15% by weight, or at least 20% by weight of zeolite or zeolite-containing catalyst (the zeolite-containing catalyst comprises at least 10 wt % zeolite, preferably at least 20 wt % zeolite, or 20 to 80 wt % zeolite, or 30 to 70 wt % zeolite);
wherein the volume average median particle size of the char is less than 200 microns, or less than 150 microns, or less than 125 microns, or less than 100 microns, or less than 75 microns (this means the size of the particle, as measured by SEM at which 50% of the total observed volume of char particles are less than 200 μm, or 150 μm, or 125 μm, etc. and where “size” refers to the largest dimension of each particle as observed in the SEM photomicrograph);
wherein the char has a mass average particle size of at least 125 microns, or at least 149 microns, or at least 250 microns, or at least 420 microns, or at least 595 microns, or at least 841 microns, or at least 2,000 microns, or the char comprises 90% or more of materials being retained on a 10 mesh, or 20 mesh, or 30 mesh, or 40 mesh, or 60 mesh, or 100 mesh, or 120 mesh screen.
wherein the amount of the sum of benzene, toluene, and xylenes in the char comprises less than 5%, or less than 2%, or less than 1%, or less than 0.5%, or less than 0.2% or less than 0.1%, or less than 0.02% by weight of the char;
wherein the sum of alkali and alkaline earth elements comprises at least 0.1%, or at least 0.2%, or at least 0.5%, or at least 1.0%,or at least 2.0% by weight of the char;
wherein the char is comprised of at least 15% by weight carbon, or at least 20% by weight carbon, or at least 25% by weight carbon, or at least 30% by weight carbon, or at least 35% by weight carbon, or at least 40% by weight carbon, or at least 50% by weight carbon, or from 15 to 95% by weight carbon, or from 20 to 90% by weight carbon, or from 25 to 85% by weight carbon, or from 30 to 75% by weight carbon, or from 40 to 70% by weight carbon;
wherein the char is comprised of at least 0.1% by weight hydrogen, or at least 0.5% by weight hydrogen, or at least 1.0% by weight hydrogen, or at least 1.5% by weight hydrogen, or at least 2.0% by weight hydrogen, or at least 2.5% by weight hydrogen, or from 0.1 to 8.0% by weight hydrogen, or from 0.5 to 6.0% by weight hydrogen, or from 1.0 to 5.0% by weight hydrogen, or from 1.5 to 3.0% by weight hydrogen;
wherein the char can be further characterized by having an enhanced oxygen content or having been treated to an oxidation treatment that provides more oxidation than exposure to air at ambient or near ambient (up to about 100 C) conditions for up to about 1 day (enhanced oxygen content means a content greater than that which would be obtained by exposure to air at ambient or near ambient (up to about 100 C) conditions for up to about 1 day);
wherein the zeolite comprises at least 40 wt % ZMS-5;
comprising at least 1 wt % (or at least 5% or 2 to 10 wt %) ammonium nitrate;
wherein the char comprises 0.1 wt % (preferably 0.01 or 0.001 wt %) or less of each of V, Ni, and As;
comprising at least 15% by weight carbon, at least 0.1% by weight hydrogen, at least 0.1% by weight of the sum of Na, K, Mg, and Ca, and at least 10% by weight of the sum of Si and Al in the form of a zeolite;
and/or having an oxygen sensitivity such that, if a 19.5 mg sample of the char is ground and exposed to an airflow of 50 mL/min then at least 10%, or at least 20%, or at least 30%, or at least 40%, or at least 50%, or at least 60%, or from 10% to 99%, or from 20% to 90%, or from 30% to 80%, or from 40% to 75% of the composition is vaporized in the range 300-700 C in a temperature programmed oxidation (TPO) experiment conducted over the range of 120-800 C with a heating rate of 30 C/minute, and preferably is vaporized at temperatures below 580 C, or below 550 C, or below 525 C, or below 500 C, or from 350 to 580 C, or from 375 to 550 C, or from 400 to 525 C.

The char-based composition may be characterized by a density such that, as measured by mercury intrusion porosimetry, the char has a bulk density less than 1.0 g/ml, or less than 0.75 g/ml, or less than 0.5 g/ml, or less than 0.35 g/ml, or less than 0.3 g/ml, or less than 0.2 g/ml, or from 0.05 to 1.0 g/ml, or from 0.1 to 0.75 g/ml, or from 0.18 to 0.5 g/ml, or a particle density less than 1.5, or less than 1.1, or less than 1.0, or less than 0.9, or less than 0.8, or less than 0.7, or less than 0.6, or less than 0.5, or less than 0.4 g/ml, or from 0.1 to 1.1 g/ml,or from 0.2 to 1.0 g/ml, or from 0.3 to 0.9 g/ml, or from 0.5 to 0.7 g/ml, or a skeletal density less than 2.0 g/ml, or less than 1.9 g/ml, or less than 1.85 g/ml, or less than 1.7 g/ml, or less than 1.55 g/ml, or less than 1.4 g/ml, or from 1.0 to 2.0 g/ml, or from 1.3 to 1.9 g/ml, or from 1.4 to 1.85 g/ml.

In a further aspect, the invention provides a method of amending soil comprising: providing char (which is a zeolite-containing char as described herein and/or a char made according to any method of the claimed invention); and mixing the char into soil.

Any of the methods described herein may include conducting the CFP process and continually removing fines of both char and catalyst. The resulting mixture of char and catalyst may be especially desirable for making a soil amendment. The invention also includes a soil amendment comprising any of the chars described herein and including at least 1 wt % zeolite, or at least 2 wt % zeolite, or in the range of 1 to 15 wt % zeolite. The invention also includes methods of making char (preferably a char selected from any of the chars described herein) by the CFP process.

Advantages of various aspects of the invention may include: increased yield of useful products, improved energy efficiency, reduced capital cost, and reduced emissions.

Separating the char and combusting it to heat the CFP reactor makes the process more energy-efficient, reduces the size and heat duty of the regenerator, removes minerals with the char, selectively removes catalyst fines generated by attrition, and extends the life of the catalyst. Separating the char and functionalizing it to allow its conversion to higher value materials improves the economics and carbon efficiency of the process.

### BRIEF DESCRIPTION OF THE DRAWINGS

FIG. 1 shows a conceptual catalytic fast pyrolysis process showing major energy (--) and mass (→) flow paths.

FIG. 2 illustrates a conceptual process for converting biomass into aromatics with char separation.

FIG. 3 illustrates static mixers and diverters to enhance char particle comminution. Top (3a) shows the schematic of a mixing device that can be inserted into a flow pipe. Center (3b) shows schematics of several means of increasing particle-wall contact by modifying the riser design. Bottom (3c) panel shows an additional scheme for mixing and enhancing particle-wall and particle-particle interactions by stream division within a pipe.

FIG. 4 is a photomicrograph of a char sample.

FIG. 5 shows compositions of two char fractions separated from a CFP process.

FIG. 6 shows temperature programmed oxidation curves for char mixed with catalyst, char mixed with silica, and coked catalyst.

FIG. 7 shows cumulative weight loss vs temperature for char mixed with catalyst, char mixed with silica, and coked catalyst in a TPO experiment.

FIG. 8 illustrates electrostatic separation apparatus.

### GLOSSARY

As used herein, the terms “aromatics” or “aromatic compound” are used to refer to a hydrocarbon compound or compounds comprising one or more aromatic groups such as, for example, single aromatic ring systems (e.g., benzyl, phenyl, etc.) and fused polycyclic aromatic ring systems (e.g. naphthyl, 1,2,3,4-tetrahydronaphthyl, etc.). Examples of aromatic compounds include, but are not limited to, benzene, toluene, indane, indene, 2-ethyl toluene, 3-ethyl toluene, 4-ethyl toluene, trimethyl benzene (e.g., 1,3,5-trimethyl benzene, 1,2,4-trimethyl benzene, 1,2,3-trimethyl benzene, etc.), ethylbenzene, styrene, cumene, methylbenzene, propylbenzene, xylenes (e.g., p-xylene, m-xylene, o-xylene), naphthalene, methyl-naphthalene (e.g., 1-methyl naphthalene), anthracene, 9,10-dimethylanthracene, pyrene, phenanthrene, dimethyl-naphthalene (e.g., 1,5-dimethylnaphthalene, 1,6-dimethylnaphthalene, 2,5-dimethylnaphthalene, etc.), ethyl-naphthalene, hydrindene, methyl-hydrindene, and dymethyl-hydrindene. Single- ring and/or higher ring aromatics may also be produced in some embodiments. Aromatics also include single and multiple ring compounds that contain heteroatom substituents, ie phenol, cresol, benzofuran, aniline, indole, thiophene, etc.

As used herein, the term “alkali and alkaline earth metals” (AAEMs) comprise the metals in Groups 1 and 2 of the Periodic Table as agreed by the International Union of Pure and Applied Chemistry (IUPAC) including Li, Na, K, Rb, Cs, Fr, Be, Mg, Ca, Sr, Ba and Ra. The term alkali and alkaline earth metals may also comprise additional elements that are frequently found in biomass along with the Group 1 and 2 elements, including Si, P, Al, Fe, Cu, Zn, Mn, or other metals in small concentrations, or combinations of these. The term alkali and alkaline earth metals is meant to convey the sum of the elements other than C, H, O, N and S that are found in biomass and are not susceptible to conversion to hydrocarbonaceous fluid products. These elements are often found as salts, oxides, or in combination with various organic molecules, and are sometimes referred to as minerals.

As used herein, the term “biomass” is given its conventional meaning in the art and is used to refer to any organic source of energy or chemicals that is renewable. Its major components can be: (1) trees (wood) and all other vegetation; (2) agricultural products and wastes (corn, fruit, garbage ensilage, etc.); (3) algae and other marine plants; (4) metabolic wastes (manure, sewage), and (5) cellulosic urban waste. Examples of biomass materials are described, for example, in Huber, G. W. et al, “Synthesis of Transportation Fuels from Biomass: Chemistry, Catalysts, and Engineering,” Chem. Rev. 106, (2006), pp. 4044-4098.

Biomass is conventionally defined as the living and recently dead biological material that can be converted for use as fuel or for industrial production. The criterion as biomass is that the material should be recently participating in the carbon cycle so that the release of carbon in the combustion process results in no net increase averaged over a reasonably short period of time (for this reason, fossil fuels such as peat, lignite and coal are not considered biomass by this definition as they contain carbon that has not participated in the carbon cycle for a long time so that their combustion results in a net increase in atmospheric carbon dioxide). Most commonly, biomass refers to plant matter grown for use as biofuel, but it also includes plant or animal matter used for production of fibers, chemicals or heat. Biomass may also include biodegradable wastes or byproducts that can be burnt as fuel or converted to chemicals, including municipal wastes, green waste (the biodegradable waste comprised of garden or park waste, such as grass or flower cuttings and hedge trimmings), byproducts of farming including animal manures, food processing wastes, sewage sludge, black liquor from wood pulp or algae. Biomass excludes organic material which has been transformed by geological processes into substances such as coal, oil shale, or petroleum. Biomass is widely and typically grown from plants, including miscanthus, spurge, sunflower, switchgrass, hemp, corn (maize), poplar, willow, sugarcane, and oil palm (palm oil) with the roots, stems, leaves, seed husks, and fruits all being potentially useful. Processing of the raw material for introduction to the processing unit may vary according to the needs of the unit and the form of the biomass. Biomass can be distinguished from fossil-derived carbon by the presence of ¹⁴C in amounts significantly above that found in fossil fuels. Any of the products described herein are preferably derived from biomass.

As used herein the term “Catalytic Fast Pyrolysis” (CFP) refers to a process for converting hydrocarbonaceous materials to chemicals, fuels, or chemicals and fuels by rapid heating in the presence of a catalyst. Examples of apparatus and process conditions suitable for CFP are described in U.S. Pat. No. 8,277,643 of Huber et al., in US Patent Application US 2012/0203042A1, and in US Patent Application 2013/0060070A1 of Huber et al. that are incorporated herein by reference. Conditions for CFP of biomass may include one or any combination of the following features (which are not intended to limit the broader aspects of the invention): a zeolite catalyst, a ZSM-5 catalyst; a zeolite catalyst comprising one or more of the following metals: titanium, vanadium, chromium, manganese, iron, cobalt, nickel, copper, zinc, gallium, platinum, palladium, silver, phosphorus, sodium, potassium, magnesium, calcium, tungsten, zirconium, cerium, lanthanum, and combinations thereof; a fluidized bed, circulating bed, or riser reactor; an operating temperature in the range of 300° to 1000° C.; and/or a solid catalyst-to-biomass mass ratio of between 0.1 and 40.

As used herein the term ‘catalyst’ has its conventional meaning, i.e. a material added to a process to increase the rate of chemical reactions. Catalyst components useful in the context of this invention can be selected from any catalyst known in the art, or as would be understood by those skilled in the art. Catalysts promote and/or effect reactions. Thus, as used herein, catalysts lower the activation energy (increase the rate) of a chemical process, and/or improve the distribution of products or intermediates in a chemical reaction (for example, a shape selective catalyst). Examples of reactions that can be catalyzed include: dehydration, dehydrogenation, isomerization, hydrogen transfer, aromatization, decarbonylation, decarboxylation, aldol condensation, molecular cracking and decomposition, combinations thereof, and other reactions. Catalyst components can be considered acidic, neutral, or basic, as would be understood by those skilled in the art.

For catalytic fast pyrolysis (CFP), particularly advantageous catalysts include those containing internal porosity selected according to pore size (e.g., mesoporous and pore sizes typically associated with zeolites), e.g., average pore sizes of less than 100 Angstroms (Å), less than 50 Å, less than 20 Å, less than 10 Å, less than 5 Å, or smaller. In some embodiments, catalysts with average pore sizes of from 5 Å to 100 Å may be used. In some embodiments, catalysts with average pore sizes of between 5.5 Å and 6.5 Å, or between 5.9 Å and 6.3 Å may be used. In some cases, catalysts with average pore sizes of between 7 Angstroms and 8 Å, or between 7.2 Å and 7.8 Å may be used.

In some preferred embodiments of CFP, the catalyst may be selected from naturally occurring zeolites, synthetic zeolites, and combinations thereof. In certain embodiments, the catalyst may be a ZSM-5 zeolite catalyst, as would be understood by those skilled in the art. Optionally, such a catalyst can comprise acidic sites. Other types of zeolite catalysts include: ferrierite, zeolite Y, zeolite beta, mordenite, MCM-22, ZSM-23, ZSM-57, SUZ-4, EU-1, ZSM-11, ZSM-22, SAPO-31, SSZ-23, among others. Catalyst compositions particularly advantageous in the CFP process fluidized bed reactor of the present invention comprise a crystalline molecular sieve characterized by a silica to alumina mole ratio (SAR) greater than 12 and a constraint index (CI) from 1 to 12. The method by which CI is determined is described more fully in U.S. Pat. No. 4,029,716, incorporated by reference for details of the method. Non-limiting examples of these crystalline molecular sieves are those having the structure of ZSM-5, ZSM-11, ZSM-12, ZSM-22, ZSM-23, ZSM-35, ZSM-48, ZSM-50 or combinations thereof. In other embodiments, non-zeolite catalysts may be used; for example, WOx/ZrO₂, aluminum phosphates, etc. In some embodiments, the catalyst may comprise a metal and/or a metal oxide. Suitable metals and/or oxides include, for example, nickel, palladium, platinum, titanium, vanadium, chromium, manganese, iron, cobalt, zinc, copper, gallium, and/or any of their oxides, among others. In some cases promoter elements chosen from among the rare earth elements, i.e., elements 57-71, cerium, zirconium or their oxides for combinations of these may be included to modify activity or structure of the catalyst. In addition, in some cases, properties of the catalysts (e.g., pore structure, type and/or number of acid sites, etc.) may be chosen to selectively produce a desired product.

“Char” is a term applied to the carbon rich (at least 20 mass % C) solid material that has been at least partially converted from biomass in a combustion, pyrolysis, or catalytic pyrolysis process. Char typically contains a high percentage of carbon, some hydrogen, and some amount of oxygen, and may also contain some of the other elements that were present in the biomass that was reacted in the process, such as Ca, K, P, Na, Mg, Mn, Si, S, N, Fe, or other elements. Char may appear similar in shape and overall structure to the initial biomass particles that were reacted, or it may appear to have been ground to finer particles in the process, or it may be agglomerated into larger particles, or combinations of these. In some instances char may contain substantial portions of catalyst that have become intermingled with the carbonaceous material. Additional characteristics of char are provided in the detailed description section. Char is oxidized at lower temperatures (temperature of maximum rate of mass loss) than the temperature at which coke or coked catalyst oxidizes in controlled oxidation experiments. Char has lower particle density and lower bulk density than coke or coked catalyst.

As used herein, the term “coke” is given its conventional meaning in the art and is used to refer to carbon rich solid deposits on catalysts or other materials. Coke deposits are typically removed by combustion in a catalyst regeneration process. Coke is distinct from char in that coke is typically deposited in the pores of catalysts or on the surface, is more highly aromatic, and less reactive than char. In many instances the separation of coke and char is not facile and coke and char are often considered together as solid products.

As used herein, the terms “olefin” or “olefin compound” (a.k.a. “alkenes”) are given their ordinary meaning in the art, and are used to refer to any unsaturated hydrocarbon containing one or more pairs of carbon atoms linked by a double bond. Olefins include both cyclic and acyclic (aliphatic) olefins, in which the double bond is located between carbon atoms forming part of a cyclic (closed-ring) or of an open-chain grouping, respectively. In addition, olefins may include any suitable number of double bonds (e.g., monoolefins, diolefins, triolefins, etc.). Olefins with two double bonds are often referred to as dienes. Examples of olefin compounds include, but are not limited to, ethene, propene, allene (propadiene), 1-butene, 2-butene, isobutene (2 methyl propene), butadiene, and isoprene, among others. Examples of cyclic olefins include cyclopentene, cyclohexene, cycloheptene, among others. Aromatic compounds such as toluene are not considered olefins; however, olefins that include aromatic moieties are considered olefins, for example, benzyl acrylate or styrene.

“Oxygenates” include any organic compound that contains at least one atom of oxygen in its structure such as alcohols (methanol, ethanol, etc.), acids (e.g. acetic acid, propionic acid, etc.), aldehydes (eg formaldehyde, acetaldehyde, etc), esters (eg methyl acetate, ethyl acetate, etc.), ethers (eg dimethyl ether, diethyl ether, etc.), aromatics with oxygen containing substituents (eg phenol, cresol, benzoic acid etc.), cyclic ethers, acids, aldehydes, and esters (e.g. furan, furfural, etc.), and the like.

As used herein, the terms “pyrolysis” and “pyrolyzing” are given their conventional meaning in the art and are used to refer to the transformation of a compound, e.g., a solid hydrocarbonaceous material, into one or more other substances, e.g., volatile organic compounds, gases, char, and coke, by heat, preferably without the addition of, or in the absence of, O₂. Preferably, the volume fraction of O₂ present in a pyrolysis reaction chamber is 0.5% or less. Pyrolysis may take place with or without the use of a catalyst. “Catalytic pyrolysis” refers to pyrolysis performed in the presence of a catalyst, and may involve steps as described in more detail in U.S. Pat. No. 8,277,643 of Huber et al., in US Patent Application US 2012/0203042A1, and in US Patent Application 2013/0060070A1 of Huber et al., and below. Examples of catalytic pyrolysis processes are outlined, for example, in Huber, G. W. et al, “Synthesis of Transportation Fuels from Biomass: Chemistry, Catalysts, and Engineering,” Chem. Rev. 106, (2006), pp. 4044-4098.

The ‘recovery’ of a component is the fraction (or percent) of that component that is present in the recovered product stream(s) compared to the amount of that component that is present in the reactor effluent stream. For example if 10 grams of product A is present in the raw effluent and 8.5 grams of product A is present in the recovered product stream(s), then the recovery of A is 8.5/10 or 0.85 (85%).

“Reaction zone” refers to a zone in a CFP reactor in which catalyst and biomass are present at a temperature of at least 300° C., and includes the volume in which catalyst is in contact with the biomass feed but excludes the volume of inlets and outlets and separators through which some catalyst and biomass are transported.

As is standard patent terminology, the term “consisting essentially of” excludes the presence of additional steps that would materially affect the method or components that would materially affect the product. In general, any of the inventive methods or products that are defined using the term “comprising” may also be characterized using the more restrictive term “consisting essentially of” or, in the narrowest case, “consisting of.” In addition, any of the method and/or product steps described herein are intended to be encompassed within any of the inventive methods or products described herein.

### DETAILED DESCRIPTION OF THE INVENTION

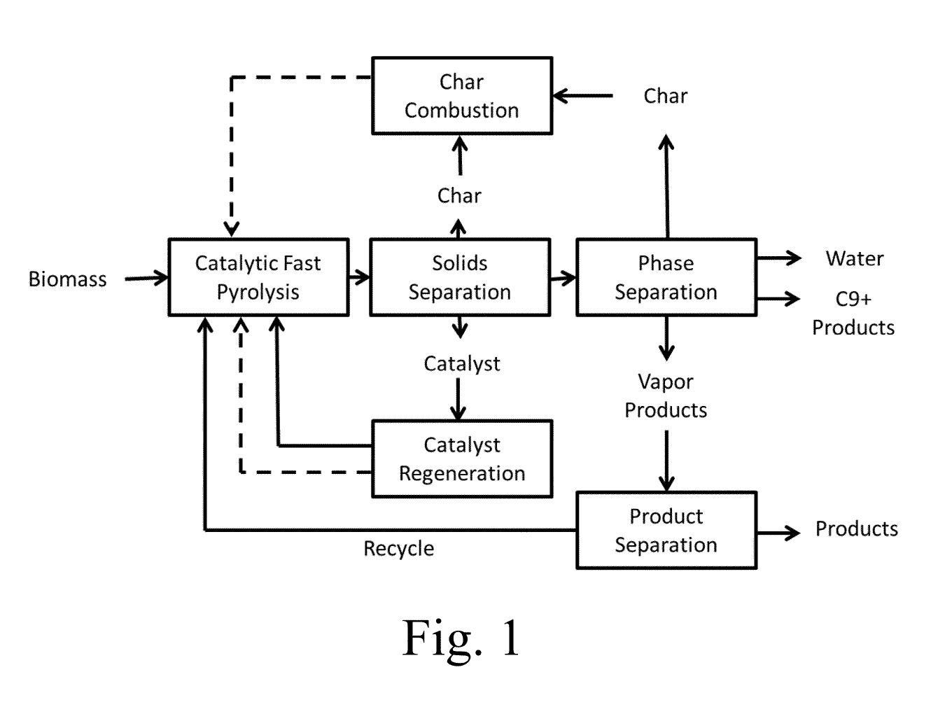

FIG. 1 shows the primary paths for the flow of mass and energy in one configuration of a conceptual CFP process. Biomass is pyrolyzed in the presence of a catalyst in the CFP reactor. The solid products of the process are separated from the vapor products, with the vapors being fed to a product recovery and separation system. A portion of the solid char is separated and optionally combusted to provide energy to drive the CFP process. The used, coked catalyst is separated and regenerated to restore its activity and provide heat for the CFP process. Excess heat from the catalyst regeneration or the char combustion, or both, can be exported and utilized elsewhere (not shown). Many of the heat recovery and heat exchange processes and some mass flows are omitted from this conceptual process.

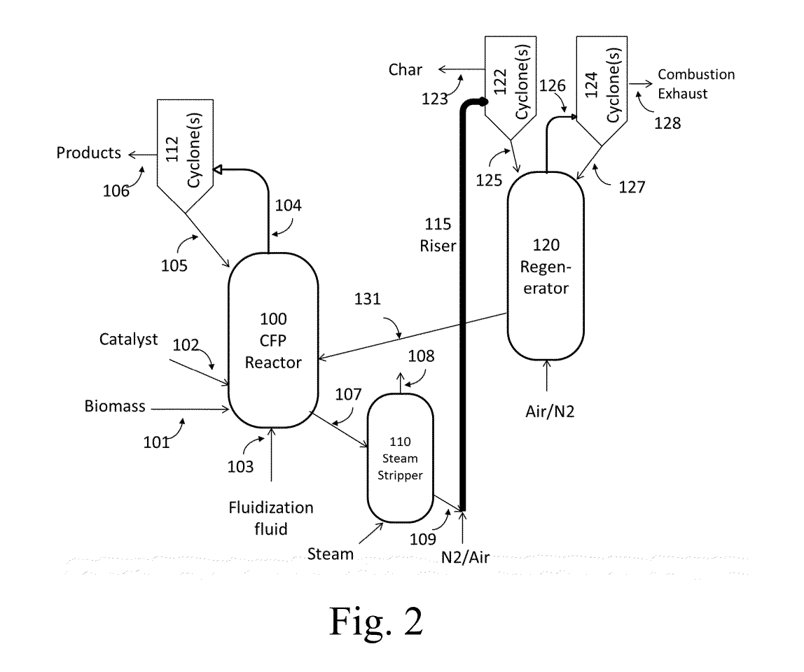

FIG. 2 shows an exemplary process for converting biomass to useful products comprising aromatics (BTX), olefins, and other components, and separating char from the system. Biomass is introduced along with a recycle gas or transport fluid via stream 101 into the CFP reactor 100. Catalyst can be introduced to the CFP reactor via stream 102 along with a transport fluid. The CFP reactor is a fluidized bed catalytic reactor that is fluidized by a portion of recycle gas or other fluid, 103. The products from the CFP reactor are separated from any catalyst, ash, or char that is carried along with the fluid stream 104 into one or more cyclones 112. Solids can be returned to the reactor via stream 105 and the product mixture sent to a product recovery and separation system (not shown). Optionally, a portion of stream 105 can be removed from the system and discarded or sent to catalyst regenerator 120 or sent to steam stripper 110. Optionally, a portion of stream 105 can be sent to a char combustion unit (not shown) or discarded. The catalyst removed from the reactor in stream 107 is passed into a steam stripper, 110. In the steam stripper the catalyst is exposed to a flow of steam that displaces the gases and volatiles in the system. These displaced vapors and a portion of the steam can be sent to the product separation and recovery section (not shown) or otherwise used in the process. The steam-stripped catalyst in stream 109 is passed into a transfer line 115, optionally a riser, along with a transfer fluid comprising nitrogen, air, or nitrogen and air, and passed to a cyclone or series of cyclones 122 to separate char from catalyst. The char rich stream 123 can be sent to a char combustion reactor (not shown) or otherwise utilized or sold as a product. The char-depleted used catalyst of stream 125 is passed to regenerator 120 in which the coke and any remaining char are at least partially combusted with air or an oxygen containing stream. Depending on the relative sizes, densities, and natures of the char particles and catalyst particles the char rich stream can comprise stream 123 and stream 125 can comprise the char depleted used catalyst; the char-depleted used catalyst can be separated from stream 123 in an additional cyclone or cyclones, or by other means, and then sent to the regenerator 120. Regenerator 120 is optionally cooled to control the temperature within acceptable limits; the cooling unit is not shown in FIG. 2. The regenerated catalyst may be returned to the reactor via stream 131, which can optionally comprise a cooling unit. The combustion exhaust stream 126 is passed into a cyclone or series of cyclones 124 to remove the solids and then the combustion exhaust stream 128 is vented or sent to a gas cleanup system (not shown). Solids collected in the cyclones 124 may be returned to the regenerator or a portion of the solids may be removed.

In one embodiment of this invention a portion of the char recovered in the process is treated and returned to the CFP reactor. Char produced by a CFP process has been at least partially dehydrated and deoxygenated from the biomass feed, but it has not been oxidized in the CFP process. Without wishing to be bound by theory, the char from a CFP process can be expected to be more susceptible to oxidation than chars obtained from combustion or other processes that are conducted in oxidizing atmospheres, or from coal or petroleum. Char is known to combust with air at a lower temperature than coke or coked catalyst. As a result CFP char may be readily oxidized, or preferably partially oxidized, by the action of relatively mild oxidation conditions and reagents. In this regard oxidizing agents such as ozone, oxygen, diluted air, hydrogen peroxide, peracetic acid (CH₃C(O)OOH), performic acid (HC(O)OOH), isobutyl peroxide, NO₂, NO, or other gaseous or liquid oxidizing agents known to those skilled in the art, or any combination of these, can be used to partially oxidize or functionalize the char. The char treatment can be carried out with gaseous reagents or with solutions. The products of the char treatment have an increased O/C ratio as compared to the freshly produced char. The products of the char treatment have an increased content of carbon to oxygen single (C—O) and double (C═O) bonds as measured by infrared spectroscopy of the solid, liquid, or both solid and liquid products.

In a process that partially oxidizes the char with a gaseous reactant the temperature is maintained within the range from 100 C to 650 C, or from 200 C to 600 C, or from 300 C to 550 C, or less than 650 C, or less than 600 C, or less than 550 C, or less than 500 C, or less than 450 C, or less than 400 C. In a process that partially oxidizes the char with a solution reactant the temperature is maintained within the range from 20 C to 250 C, or from 50 C to 200 C, or from 60 C to 150 C, or less than 250 C, or less than 200 C, or less than 150 C, or less than 100 C, or less than 80 C, or less than 60 C. The oxidizing capability of the oxidant such as oxygen gas or hydrogen peroxide is kept at less than the stoichiometric oxygen amount needed to effect complete combustion of the char to CO₂ and water such that the oxygen in the oxidant to carbon in the char ratio (O/C ratio) is less than 1.5, less than 1.0, less than 0.8, less than 0.5, or less than 0.25, or from 0.01 to 1.5, or from 0.05 to 1.0, or from 0.1 to 0.8, or from 0.15 to 0.5.

Solution treatments of the char can include removal of at least part of the minerals that are in the freshly produced char. These processes may include washings with liquid solutions, e.g., water, H₂O₂ in water, acidic solutions, or the like. Optionally, a portion of the water solution produced in the CFP process as a by-product that contains some oxygenates and has a pH between about 2 and 6 could be used to wash the char. In one embodiment of this invention the char is used to extract oxygenates from the process water as a means of cleaning the water and providing a means for these materials to be recycled to the CFP reactor. In one embodiment the char is partially oxidized before it is washed and in another embodiment the char is washed before it is partially oxidized. At least a portion of the washed char can be fed to the CFP reactor.

Another potential treatment is ‘explosive grinding’ wherein the char is impregnated with a solvent, e.g., water, or a solution, or ammonia, and is heated rapidly above the boiling point of the solvent wherein it expands and explodes the particle. Plasma treatments of char can be used if gas phase components are desired such as CO, CO₂, olefins, or other light hydrocarbons. Char can be subjected to steam reforming conditions, e.g., temperatures above 750° C. in the presence of steam, such that the presence of the alkali elements from the biomass catalyze the reforming of the char into synthesis gas, i.e., H₂, CO, CO₂, and steam. The H₂ and CO formed in such a process can be recycled to the CFP reactor or otherwise utilized in the process or used for other purposes. In one embodiment the char produced in the CFP process is subject to gasification with CO₂, steam, or both CO₂ and steam to form gaseous mixtures comprising, CO, CO₂, H₂O, H₂, methane, and other light hydrocarbons.

In some embodiments, char according to the invention has a mass average particle size of at least 125 microns, or at least 149 microns, or at least 250 microns, or at least 420 microns, or at least 595 microns, or at least 841 microns, or at least 2,000 microns, where the “size” is measured either by manual sieving or light scattering using a Malvern Mastersizer 2000 laser diffraction system (or its equivalent); where not specified, size is to be determined by sieving. In some embodiments, the char comprises 90% or more of materials being retained on a 2000 micron (10 mesh), or 850 micron (20 mesh), or 600 micron (30 mesh), or 425 microns (40 mesh), or 250 micron (60 mesh), or 149 micron (100 mesh), or 125 micron (120 mesh) screen. Char of the invention can comprise the particles separated from the solid mixture that are at least 125 microns, or at least 149 microns, or at least 250 microns, or at least 420 microns, or at least 595 microns, or at least 841 microns, or at least 2,000 microns.

In some embodiments, char according to the invention comprises the material retained on a 2000 micron (10 mesh), or 850 micron (20 mesh), or 600 micron (30 mesh), or 425 microns (40 mesh), or 250 micron (60 mesh), or 149 micron (100 mesh), or 125 micron (120 mesh) screen after a 2 minute period of manual sieving of the material. Manual sieving is conducted according to the following protocol: Hold the individual sieve, provided with a snug-fitting pan and cover, in a slightly inclined position in one hand. Strike the side of the sieve sharply and with an upward motion against the heel of the other hand at the rate of about 150 times per minute, turn the sieve about one sixth of a revolution at intervals of about 25 strokes.

Optionally at least a portion of the char can be comminuted before it is subjected to a treatment as described above. Comminution can be accomplished by milling, grinding, kneading, chopping, crushing, pulverizing, fragmenting, or any other process that reduces the average particle size of the char, or increases the surface area of the char, or both. The comminution of the char can reduce the mass average particle size by at least 50%, or at least 60%, or at least 70%, or at least 80% of the initial mass average particle size as measured by light scattering. The comminution of the char can reduce the mass fraction of particles that have an average diameter greater than 2 mm, or greater than 1 mm, or greater than 0.5 mm, or greater than 0.3 mm, or greater than 0.2 m, or greater than 0.1 mm, by at least 50%, or at least 60%, or at least 70%, or at least 80% of the initial mass fraction of particles of the indicated average diameter as measured by light scattering. The comminution of the char can reduce the mass average particle size of the char to less than 200 microns, or less than 150 microns, or less than 125 microns, or less than 100 microns, or less than 75 microns.

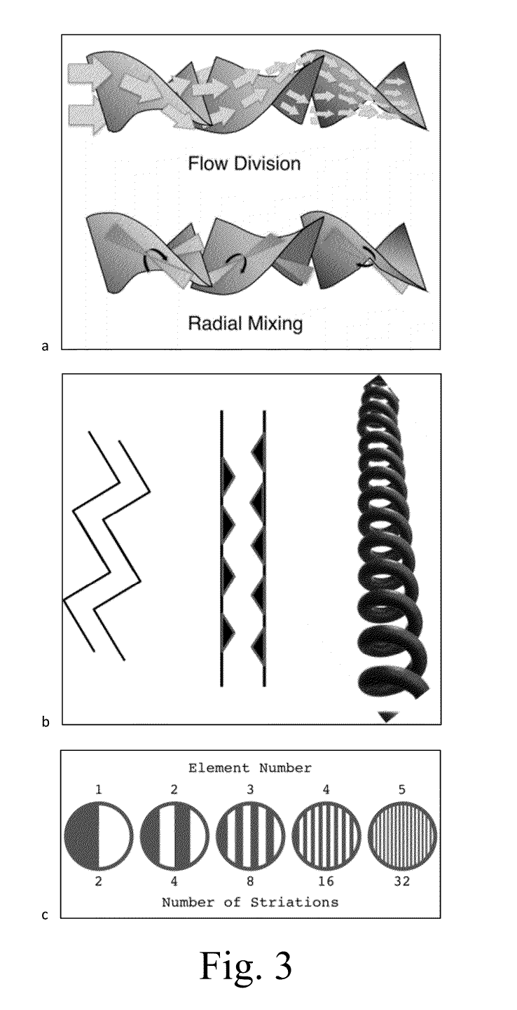

In one embodiment of this invention the riser 115 is fitted with internal fixtures such as static mixers, diverters, or the like, or is shaped in such a way that enhances the particle-wall, particle-particle, or particle-internal fixture interactions of the solids mixture and enhances comminution of the char particles. Any internal fixture or conveyance shape that enhances char attrition while not substantially enhancing catalyst attrition is envisioned. Comminution of the particles (reduction of average particle size) of char in preference to the catalyst can be achieved by attrition in a fast-flowing pipe such as the riser or transfer line from the steam stripper to the regenerator. It is believed that, for most CFP catalysts, particles of char are more friable than catalyst particles such that they will be comminuted more by solid-solid interactions. To enhance comminution of the char the transfer line or riser can be fitted with a variety of static mixing devices or diverters that increase the particle-particle contacts, particle-fixture contacts, and the particle-wall contacts. Some non-limiting examples of internal fixtures and transfer line geometries that are envisioned to enhance solid-solid contacts are shown in FIG. 3, although there are many other variations. Conditions may be chosen to selectively comminute the char without significantly comminuting the catalyst. As the catalyst is a fluid bed catalyst, manufactured to withstand operation in a fluid bed reactor, it can be expected to have more strength than the char. Char particles are normally less dense than catalyst particles as well, making them more likely to elutriate from a mixture with the more dense catalyst particles. Comminution of the char particles to a size distribution that has a similar or smaller average diameter than the size distribution of the catalyst particles will permit them to be more readily separated, such as by cyclone(s) 122 in FIG. 2. Comminuting the char after its removal from the CFP reactor with catalyst and ash makes the elutriation process more efficient, providing a more char-deficient and ash-deficient catalyst feed to the regenerator. Comminution with an impingement surface or device is a process wherein at least some of the particles impact the surface or device at an angle of attack of at least 45 degrees from the parallel to the surface or device.

In one embodiment a small amount of oxygen is introduced into the riser column to initiate a combustion reaction of the char as it moves through the riser. It is believed that partial combustion of the char could further increase the friable nature of the char and reduce the particle size rendering it more susceptible to comminution and separation from the catalyst particles, such as by cyclone(s) 122 in FIG. 2. The oxygen concentration of the conveyance fluid used to transport the catalyst and char and ash mixture through riser 115 may be less than 5%, or less than 2%, or less than 1.5%, or less than 1.0%, or less than 0.5%, or less than 0.2%, or from 0.001% to 2%, or from 0.01% to 1%, or from 0.02% to 0.5% or from 0.02% to 0.2% of the volume of the conveyance fluid mixture, or it may be substantially oxygen free.

In one embodiment of the invention any of the cyclones identified in FIG. 2 as 112, 122, and 124 may comprise more than one cyclone in series, or more than one cyclone or series of cyclones in parallel. In the case where multiple cyclones are utilized the linear velocity of the gas/solid mixture that enters each cyclone can be adjusted by changing the geometry of the cyclone, or by adding conveyance fluid to the mixture, or both. Preferably the linear velocity of the gas/solid mixture entering individual cyclones in a series of cyclones will increase with each succeeding cyclone, or at least not decrease, i.e., the linear velocity of the gas/solid mixture entering the second cyclone will be greater than or equal to the linear velocity of the gas/solid mixture entering the first cyclone, the linear velocity of the gas/solid mixture entering the third cyclone will be greater than or equal to the linear velocity of the gas/solid mixture entering the second cyclone, etc.

Char separation can occur before, concurrent with, and/or, especially, after a steam stripper is used to remove hydrocarbon products and displace the gases from the coked catalyst.

In one embodiment of this invention the char is at least partially separated from the catalyst by a solids flotation process in or after the steam stripper. Some char particles and some ash particles are less dense than catalyst particles, and thus tend to move to the upper portion of a fluidized bed of particles under appropriate agitation conditions. The flotation process is preferably a gas flotation wherein the bed is agitated by a slow flow of gas or vapor. Liquid flotation is also envisioned as being within the scope of the present invention. The liquid for the flotation separation process could include a water solution, an acidic solution, an aqueous solution containing salts such as ammonium salts, such as a water solution, or a solution in an organic solvent, or a mixed solvent with water. The pH of the flotation liquid is preferably less than 7, or less than 6, or less than 5, or less than 4, or less than 3, or from 1 to 5 or from 2 to 4. As the less dense particles rise to the top of the solids mixture they can spill over a dam and be collected or the particles of varying densities be collected at varying points using taps along the flotation device.

In some embodiments of the present invention a catalyst and char mixture is separated by a process of elutriation of the solid particles by a fluid. In one embodiment of the elutriation process a suspension of the solid particles to be separated is prepared in the elutriation fluid which is a fluid chemically inert in relation to the catalyst or char, and further in that the process comprises one or more of the following defined stages, wherein the first stage is a process for separating large particles comprising introducing a flow of the catalyst and char suspension into a vertical elutriation column, at a level between the midpoint and the bottom of the column, introducing a flow of the elutriation fluid into the column at a level lower than that of the introduction of the catalyst and char suspension, the fluid being caused to flow in the column in an ascending stream substantially under laminar flow conditions, withdrawing from the top of the column a catalyst suspension substantially free from large char particles or catalyst and char agglomerates and, withdrawing from the bottom of the column a suspension mainly comprising large particles, and wherein an optional second stage is a process for separating the fine particles comprising introducing a flow of the catalyst suspension recovered from the first elutriation column into a vertical elutriation column above the midpoint, introducing a flow of the elutriation fluid into the column at a lower level, the fluid being caused to flow in the column in an ascending stream and substantially under conditions of laminar flow, withdrawing from the top of the column elutriation fluid charged with fine catalyst and char particles and withdrawing from the bottom of the column catalyst particles substantially freed from fine particles. In the variants of the process according to the invention, therefore, the catalyst suspension in the elutriation fluid prepared during the first stage can be subjected to an elutriation operation enabling either the large or fine particles of the catalyst to be separated. The suspension can also be subjected to a double elutriation operation enabling both the large and fine particles to be separated simultaneously, the large particles being separated in the first elutriation column preferably before the fine particles are separated in the second elutriation column. Depending on process conditions and the relative sizes of the char and catalyst particles either the large particles, or fine particles, or both can comprise char or catalyst. Preferably the elutriation fluid is a gas or mixture of gases.

In one embodiment of this invention the char is at least partially separated from the catalyst by a screen, a set of screens with various holes or openings, or another size exclusion device where separation of solids occurs based on particle size differences. In some embodiments, a mixture of catalyst and char is passed through a screen (preferably upward (opposed to gravity) through the screen) with the larger particles that do not pass through the screen being recycled to the reactor or passed to the catalyst regenerator or steam stripper or the char combustor. In some alternate embodiments, a mixture of catalyst and char is passed through a screen (preferably upward (opposed to gravity) through the screen) with the smaller particles that pass through the screen being recycled to the reactor or passed to the catalyst regenerator or steam stripper. The char particles that are not recycled are collected as char for further processing. In one embodiment of this invention char is first separated from the solids mixture by size exclusion to produce a larger particle char-enriched fraction and a first smaller particle char-depleted fraction. The char-enriched fraction may be separated into a second, more enriched char fraction and a second char-depleted fraction by elutriation. The second, more-enriched char fraction may be sent to the char combustor or otherwise treated or discarded or retained for other uses. Any of these separation processes may be conducted before or, preferably, after the solids mixture has passed through a steam stripper.

In embodiments of this invention wherein char is separated and combusted in a separate vessel from the catalyst regeneration to provide heat to the CFP reactor, the char combustion can be operated at temperature of at least 500 C, or at least 600 C, or at least 700 C, or at least 800 C, or at least 900 C, or at least 1000 C, or from 700 C to 1300 C, or from 800 to 1200 C. In embodiments of this invention wherein the char is separated and combusted in a vessel separate from the catalyst regeneration to provide heat to the CFP reactor, the catalyst regeneration can be operated at temperatures of less than 750 C, or less than 700 C, or less than 650 C, or less than 625 C, or from 550 C to 750 C, or from 575 C to 700 C, or from 600 C to 650 C. Operating the regenerator at modest temperatures is advantageous since it will prolong the life of the catalyst for ZSM-5 and other zeolite catalysts.

In embodiments of this invention wherein char is separated, and combusted in a vessel separate from the catalyst regeneration to provide heat to the process, the char combustion can be conducted in a circulating fluid bed reactor, riser reactor, gasifier, counter-current gasifier, co-current gasifier, cross-draught gasifier, fluid bed gasifier, double fired gasifier, entrained bed gasifier, molten bath gasifier, heat exchange reactor, circulating loop reactor, staged combustion reactor, or any other combustion reactor as are well known to combust solids and optionally recover heat therefrom. Combustion of the char fraction is conducted in the presence of an oxygen containing gas, such as air, or oxygen-depleted air, or oxygen enriched air, or a flue gas containing oxygen, or any gas that contains sufficient oxygen to support combustion of the char. Preferably the combustion of char is conducted in the presence of a small excess of oxygen, i.e. more oxygen than is needed to effect complete conversion of the carbonaceous materials to CO₂ and water.

In embodiments of this invention wherein char is separated, and combusted in a vessel separate from the catalyst regeneration to provide heat to the process, the heat release in the catalyst regenerator is significantly reduced from the amount of heat released when the char and catalyst are not separated and are combusted together. The reduction of the heat release in the catalyst regenerator is at least 20%, or at least 33%, or at least 50%, or at least 60%, or at least 66%, or at least 75% when the char has been removed compared to the heat release when the char and coked catalyst are combusted together in the regenerator without separation.

The char separated from the process may contain a mixture of char and portions of inorganic zeolite and other inorganic materials from the catalyst in physical forms such as whole catalyst particles and as catalyst fines which are derived from the breakage of catalyst particles in the CFP process equipment. In some cases, the catalyst material is strongly attached to the char particles, perhaps by an adhesive force. The char produced in the inventive process may comprise at least 1%, or at least 10%, or at least 20%, or at least 25%, or at least 30%, or from 10 to 70%, or from 20 to 60%, or from 15 to 50% by weight of the sum of silica and alumina in the form of one or more zeolites. The char produced in the inventive process may comprise at least 1%, or at least 5%, or at least 10%, or at least 20%, or at least 30% by weight of the sum of silica and alumina in the form of one or more amorphous solid materials such as binders, clays, etc. The char produced in the inventive process may comprise at least 1%, or at least 10%, or at least 20%, or at least 25%, or at least 30%, or from 10 to 95%, or from 20 to 90%, or from 25 to 80% by weight of solid materials derived from catalysts used in the CFP process (often including binder and zeolite). This highly porous char and catalyst mixture may be a valuable soil amender as it returns carbon to the soil, provides capacity of providing porosity for trapping and releasing water to the soil, increases soil permeability, loosens the soil, and provides retention and release of various metal ions and organic materials that are contained within the inorganic catalyst material and the porous char produce in the CFP process

Moreover the CFP char produced in this process will have had compounds such as volatile polynuclear aromatics that are known to be deleterious to plant growth substantially removed during the steam stripping of the catalyst and char mixture in configurations where the char is separated within or downstream of the steam stripper. Char that has been processed by steam stripping will comprise reduced amounts of aromatics such as BTX and other volatile components. The amount of benzene plus toluene plus xylenes will be less than 5%, or less than 2%, or less than 1%, or less than 0.5%, or less than 0.2% or less than 0.1%, or less than 0.02% by weight of the char, or of sufficiently low concentration so as to render the char a non-hazardous material. The CFP char preferably contains concentrations of benzene, cresol, pyridine, or metals such that an extract of the char does not exhibit the characteristic of toxicity measured using the Toxicity Characteristic Leaching Procedure, test Method 1311 in “Test Methods for Evaluating Solid Waste, Physical/Chemical Methods,” EPA Publication SW-846, July 1992, incorporated herein by reference. In some embodiments, the char is rendered to be non-hazardous. In addition, the CFP char may comprise a portion of the metallic elements found in biomass, such as Ca, K, Na, Mg, Si, P, Fe, etc., which are known nutrients for the growth of plant life. The CFP char of the present invention preferably has amounts of Ni, Cr, V, Ag, Se, Hg, Pb, Cd, Ba, As, and chlorides that are below those considered to categorize the char as a hazardous material.

Furthermore the CFP char that comprises a portion of the acidic zeolite catalyst used in the CFP process will have a pH much closer to that which promotes plant growth; chars derived from non-catalyzed pyrolysis processes are often very strongly basic, particularly when they contain ash, and thus need pH adjustment before they can be used as soil amenders. The char produced with the methods of the current invention can produce upon exposure to water a solution which has a pH of 7 or less, 6 or less, 5 or less, or 4 or less, or from 2 to 7, or from 2.5 to 6, or from 3 to 5. Thus, a preferred char of the invention can be characterized by having a latent pH such that, if 10 g of the char is dispersed in 50 g of distilled water with stifling for 10 minutes, the water will have the characteristic pH described above. Separation and removal of the char from the CFP process also provides a means of removing the ash-forming elements from the system, removing catalyst fines from the process, extending the life of the catalyst, reducing the size and cost of the catalyst regenerator, and improving the operability of the process.

Char that contains a portion of the acidic inorganic and zeolite material mixtures will have further benefits for soil nitrogen fertilization and controlled release when used as a soil amendment material in conjunction with ammonia fertilizer applications because the solid acid sites have a capacity to adsorb and desorb basic molecules such as ammonia and ammonium ions.

Char separation, treatment, or combustion, or any combination of these may be part of a comprehensive control process for adjusting the particle size distribution of the catalyst inventory in the process. Fine catalyst particles separated from the char may be optionally returned to the CFP reactor in appropriate amounts and rates to maintain the desired particle size distribution of the catalyst.

The char produced from the CFP process of the present invention, or fractions separated therefrom, comprises a portion of catalyst that can range from 1 to 95% by weight, or from 2 to 80% by weight, or from 5 to 70% by weight, or from 10 to 60% by weight, or from 15 to 50% by weight, or from 20 to 40% by weight, or at least 1% by weight, or at least 2% by weight, or at least 5% by weight, or at least 10% by weight, or at least 15% by weight, or at least 20% by weight of the char. The char produced from the CFP process of the present invention comprises alkali and alkaline earth metals (taken together as AAEM's) such as Na, K, Mg, and Ca, or combinations of these. The char produced from the CFP process of the present invention comprises at least 0.01% by weight AAEM's, or at least 0.1% by weight AAEM's, or at least 0.2% by weight AAEM's, or at least 0.5% by weight AAEM's, or at least 1.0% by weight AAEM's, at least 2.0% by weight AAEM's. The char produced from the CFP process of the present invention or a fraction separated therefrom comprises at least 15% by weight carbon, or at least 20% by weight carbon, or at least 25% by weight carbon, or at least 30% by weight carbon, or at least 35% by weight carbon, or at least 40% by weight carbon, or at least 50% by weight carbon, or from 15 to 95% by weight carbon, or from 20 to 90% by weight carbon, or from 25 to 85% by weight carbon, or from 30 to 75% by weight carbon, or from 40 to 70% by weight carbon. The char produced from the CFP process of the present invention, or a fraction separated therefrom, comprises at least 0.1% by weight hydrogen, or at least 0.5% by weight hydrogen, or at least 1.0% by weight hydrogen, or at least 1.5% by weight hydrogen, or at least 2.0% by weight hydrogen, or at least 2.5% by weight hydrogen, or from 0.1 to 8.0% by weight hydrogen, or from 0.5 to 6.0% by weight hydrogen, or from 1.0 to 5.0% by weight hydrogen, or from 1.5 to 3.0% by weight hydrogen.

The char produced from the inventive process may have a bulk density less than 1.0 g/ml, or less than 0.75 g/ml, or less than 0.5 g/ml, or less than 0.35 g/ml, or less than 0.3 g/ml, or less than 0.2 g/ml, or from 0.05 to 1.0 g/ml, or from 0.1 to 0.75 g/ml, or from 0.18 to 0.5 g/ml. The char of the inventive process may have a particle density less than 1.5, or less than 1.1, or less than 1.0, or less than 0.9, or less than 0.8, or less than 0.7, or less than 0.6, or less than 0.5, or less than 0.4 g/ml, or from 0.1 to 1.1 g/ml,or from 0.2 to 1.0 g/ml, or from 0.3 to 0.9 g/ml, or from 0.5 to 0.7 g/ml. The skeletal density of the char of the inventive process may be less than 2.0 g/ml, or less than 1.9 g/ml, or less than 1.85 g/ml, or less than 1.7 g/ml, or less than 1.55 g/ml, or less than 1.4 g/ml, or from 1.0 to 2.0 g/ml, or from 1.3 to 1.9 g/ml, or from 1.4 to 1.85 g/ml.

The char of the present invention may comprise a solid material produced in a CFP process in which at least 10%, or at least 20%, or at least 30%, or at least 40%, or at least 50%, or at least 60%, or from 10% to 99%, or from 20% to 90%, or from 30% to 80%, or from 40% to 75% of the material that is lost by combustion over the range 300-700 C, is lost at temperatures below 580 C, or below 550 C, or below 525 C, or below 500 C, or from 350 to 580 C, or from 375 to 550 C, or from 400 to 525 C in a temperature programmed oxidation (TPO) experiment conducted in air flow with a rate less than 5,000 volumes of air per volume of sample over the range 120-800 C with a heating rate of 30 C/minute. The char of the present invention may comprise a solid material produced in a CFP process for which the maximum weight loss as measured in a temperature programmed oxidation (TPO) experiment conducted in air flow with a rate less than 5,000 volumes of air per volume of sample over the range 120-800 C with a heating rate of 30 C/minute occurs at less than 580 C, or less than 550 C, or less than 525 C, or less than 500 C, or less than 490 C, or less than 480 C, or from 350 to 580 C, or from 400 to 550 C, or from 425 to 500 C, or from 450 to 490 C.

The pH of the char of the inventive process may be adjusted by treatment with acid or base to meet the particular soil requirements. The char of the inventive process may be treated with acid for use as a soil amendment material. Acids used for the char treatment may include acetic, formic, nitric, sulfuric, propionic, or carbonic acids, or a portion of the water produced in the CFP process, or other acids known to those skilled in the art, or combinations of these. The char of the inventive process may be treated with a basic solution for use as a soil amendment material. The basic material may comprise a portion of the water produced in the CFP process, or a wash solution obtained from washing catalysts used in the CFP process, or a solution prepared using ash produced by combustion of char or biomass in a CFP process, or other basic solutions known to those skilled in the art, or combinations of these.

The steam stripper in the present invention may be operated over a wide range of conditions. The temperature of the steam stripper may be within the range from 100 to 700 C, or from 250 to 650 C, or from 400 to 625 C, or from 500 to 600 C, or may be at least 100 C, or at least 250 C, or at least 400 C, or at least 500 C, or less than 700 C, or less than 650 C, or less than 600 C. The pressure in the steam stripper may be from 1 to 20 bara (absolute pressure), or from 2 to 15 bara, or from 3 to 10 bara, or from 4 to 8 bara, or at least 1 bara, or at least 2 bara, or at least 3 bara, or at least 4 bara, or less than 20 bara, or less than 10 bara, or less than 8 bara.

The CFP process may be conducted at a temperature of 400° C. or more, and the product stream 104 from 100 in FIG. 2 is typically at a temperature of 300-620° C., or 400-600° C., or 500-575° C., and a pressure of 100 kPa to 5000 kPa, or 200 kPa to 1500 kPa, or 300 kPa to 700 kPa, or at least 200 kPa, or at least 300 kPa or at least 400 kPa. (Pressures are expressed as absolute pressures.) The raw product stream from the CFP reactor comprises aromatics, olefins, oxygenates, paraffins, H₂, CH₄, CO, CO₂, water, char, ash, coke, catalyst fines, and a host of other compounds. On a water-free and solids-free basis the raw product stream can comprise 20 to 60%, or 25 to 55% or 30 to 50%, or at least 20%, or at least 25%, or at least 30% CO calculated on a mass % basis. On a water-free and solids-free basis the raw product stream can comprise 10 to 50%, or 15 to 40%, or 20 to 35%, or at least 5%, or at least 10%, or at least 15%, or at least 20% CO₂ calculated on a mass % basis. On a water-free and solids-free basis the raw product stream can comprise 0.1 to 2.0, or 0.2 to 1.5, or 0.3 to 0.75%, or at least 0.1%, or at least 0.2%, or at least 0.3%, or less than 10%, or less than 5%, or less than 1% H₂ calculated on a mass % basis. On a water-free and solids-free basis the raw product stream can comprise 2 to 15, or 3 to 10, or 4 to 8%, or less than 15%, or less than 10%, or less than 8% CH₄ calculated on a mass % basis. On a water-free and solids-free basis the raw product stream can comprise 2 to 40, or 3 to 35 or 4 to 30%, or less than 40%, or less than 35%, or less than 30%, or less than 20% BTX calculated on a mass % basis. On a water-free and solids-free basis the raw product stream can comprise 0.1 to 10%, or 0.2 to 5%, or 0.3 to 3%, or less than 5%, or less than 3%, or less than 2% oxygenates calculated on a mass % basis. On a water-free and solids-free basis the raw product stream can comprise 1 to 15%, or 2 to 10%, or 3 to 6% C2-C4, or at least 1%, or at least 2%, or at least 3% olefins calculated on a mass % basis. On a water-free and solids-free basis the raw product stream can comprise a vapor mixture where the sum of CO and CO₂ is from 30 to 90%, or from 40 to 85%, or from 50 to 80%, calculated on a mass % basis.

### EXAMPLE 1

A 10 g sample of commercially available biochar obtained from Waste to Energy Solutions, Inc. was ground to powder with mortar and pestle. The powder was suspended in 50 g of water in a beaker, stirred with a magnetic stirrer. The pH was measured as 7.64 after 5 minutes and as 7.65 after 90 minutes.

CFP char obtained from the pyrolysis of hardwood pellets with a commercial H-ZSM-5 catalyst was separated from the bulk of the catalyst by sieving. The larger particles that were retained on a 40 mesh sieve (0.4 mm) were designated as char and the smaller particles that passed through a 40 mesh sieve were discarded as being largely catalyst. Analysis showed that the char sample contained approximately 30% carbon by weight. A 10 g sample of CFP char was suspended in 50 g of water and stirred with a magnetic stirrer as above. The pH was measured as 6.83 after 5 minutes, 3.24 after 60 minutes, and 3.26 after 90 minutes.

### EXAMPLE 2

A 4-inch diameter (10 cm OD) fluid bed reactor, charged with 500 g of a commercial spray dried H-ZSM-5 catalyst with average particle size of about 110 microns diameter and less than 10% larger than 210 microns diameter that had been calcined in air at 600 C for 2 hours, was used for biomass conversion and regenerated for 4 cycles. The used catalyst was fluidized with 2.3 standard liters per minute (SLPM) of N₂ flow and heated to 575 C. Ground hardwood pellets with 98% of the particles from 0.25 to 1.4 mm (14-60 mesh) that contained 48.25% C and 5.96% H and 0.62% ash were charged to the feed hopper and fed into the reactor at the rate of 4.7 g/minute with a carrier flow of 3.2 SLPM of N₂ for 225 minutes for a total feed of 1059.8 g of biomass (6.5 g ash), and fresh catalyst was added at a rate of 2.9 g/minute. A steady flow of solids was metered at the outlet of the reactor to keep the total bed at a constant volume. Vapor products were collected in a series of cold traps and the noncondensible gaseous products were collected and sampled.

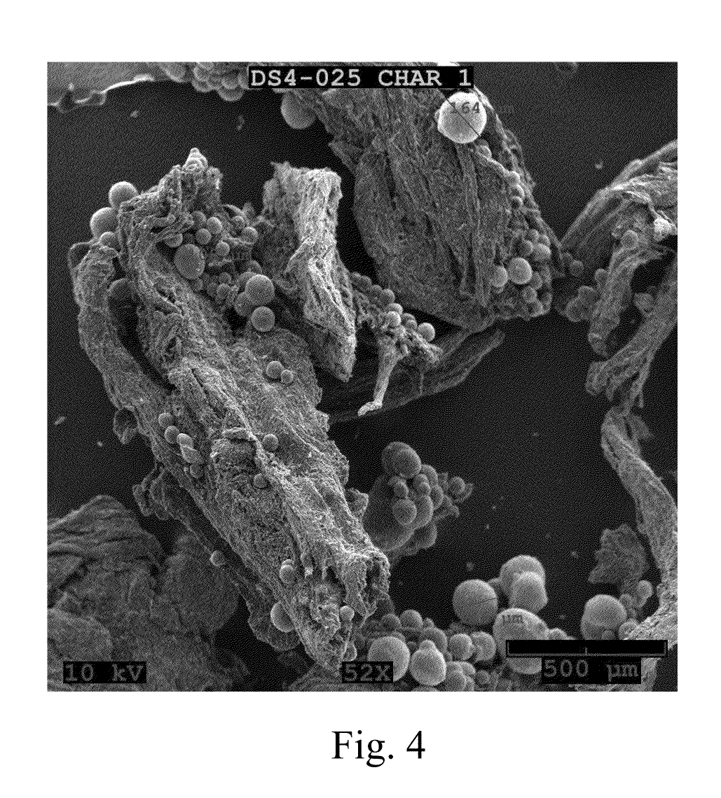

The cooled solids collected from the reactor were passed through a 60 mesh screen (250 microns) to separate a 282.5 g fraction of particles larger than 0.25 mm that was designated as catalytic char and a fraction of particles that were smaller than 0.25 mm designated as coked catalyst. A photomicrograph of a representative sample of the char appears in FIG. 4. The char sample was separated by sieving into fractions as indicated in Table 1. Some breakage of particles produced material smaller than 0.25 mm. Each fraction was dried to provide a moisture content of the char (Loss on Drying, LOD). The dried material was combusted to provide the organic content of the char (Loss on Ignition, LOI). Parts of the dried samples were sent to Galbraith Laboratories for carbon and hydrogen analysis. Oxygen was calculated by difference and the data are collected in Table 2. The residue was weighed to obtain the inorganics content. As can be seen from the photomicrograph, the char particles are relatively large and irregularly shaped while the catalyst particles are much smaller and roughly spherical. Thus, the char/catalyst mixture that has not been subjected to comminution will typically contain char particles that have a volume average size that is at least 10 times greater than the volume average size of the catalyst particles.

The 20-40 mesh (850-425 microns) and 40-60 mesh (425-250 microns) particle fractions of the char were evaluated for bulk, particle, and skeletal density by mercury intrusion. Bulk density is defined as the mass of a material divided by the volume occupied by the material in a loosely packed form; it includes the volume of the solid particles, the voids between particles, and the internal pore volume. Particle density is the density of each particle; it includes internal pore volume but excludes the voids between particles. Skeletal density is calculated by dividing the mass of the material by the volume of the solid skeleton of the material that is determined by subtracting the volume of the voids and internal pores obtained from mercury intrusion measurements from the bulk volume (mass/(bulk volume—total Hg intrusion volume)); it includes only the solid materials. The data are collected in Table 3.

Samples of the 20-40 mesh (850-425 microns) and 40-60 mesh (425-250 microns) char fractions were regenerated by combustion in a muffle furnace at 600 C for two hours to remove all organics and produce a residue comprising the inorganic materials. A particle size distribution (PSD) was obtained for the inorganic residue. There are two peaks from the PSD analysis. The large peak centered near 100 microns is assigned to the catalyst, and the smaller peak centered around 15 microns was assigned as ash. An integration of the area below each peak was used to estimate the volume ratio between catalyst and ash particles. From the bulk density of the catalyst and char, a weight fraction of the char was calculated for each and is presented as the mass percent of the original char fraction in Table 3.

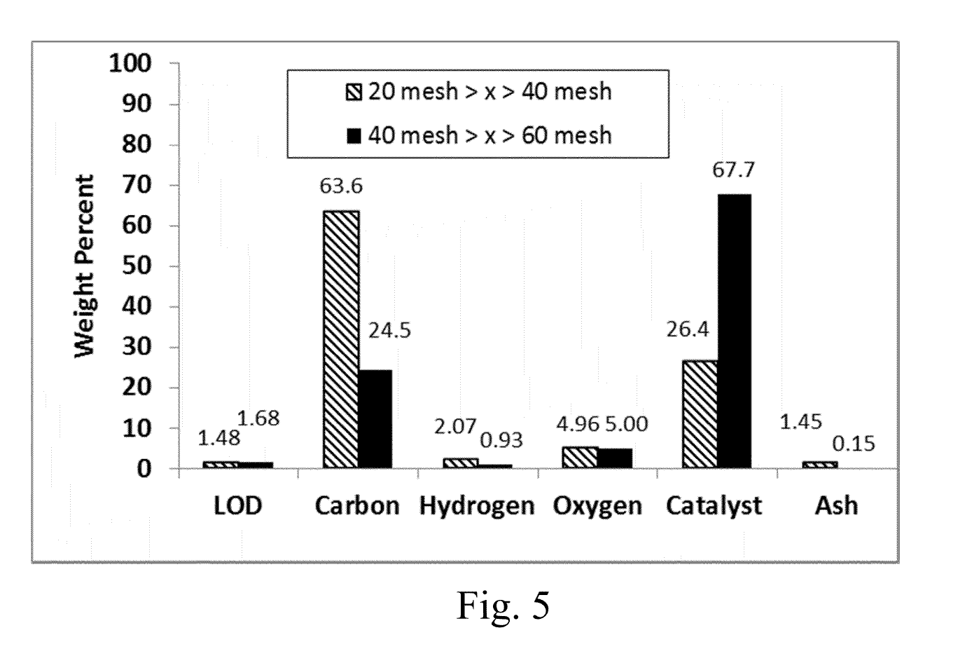

FIG. 5 presents a comparison of the compositions of two fractions of the char separated from the CFP process.

TABLE 1
Char fractions separated by particle size.

| | | | | | | | Hydro- |
|---|---|---|---|---|---|---|---|
| | Particle | Mass | | | | Carbon | gen |
| Screen | Size | Fraction | LOD | LOI | Residue | content | content |
| Size | mm | % | Wt % | Wt % | Wt % | Wt % | Wt % |
| 10-14 | >1.4 | 0.6 | | na | | na | na |
| 14-20 | 0.85-1.4 | 21.0 | 0.9 | 85.6 | 13.5 | 79.9 | 2.6 |
| 20-40 | 0.42-0.85 | 45.8 | 1.5 | 70.6 | 27.9 | 63.6 | 2.1 |
| 40-60 | 0.25-0.42 | 19.0 | 1.7 | 30.5 | 67.9 | 24.5 | 0.9 |
| 60-230 | 0.07-0.25 | 11.4 | 2.0 | 17.3 | 80.7 | 16.9 | <1 |
| >230 | <0.07 | 2.1 | 2.2 | 7.5 | 90.2 | 6 | <1 |

TABLE 2
Carbon, hydrogen, and oxygen compositions of the combustion products
produced by combustion of the various char fractions.

| | | | Oxygen | Carbon | Hydrogen |
|---|---|---|---|---|---|
| Screen Size | Carbon | Hydrogen | (1) | Distribution | Distribution |
| mesh | Wt % | Wt % | Wt % | % | % |
| 10-14 | 94.9 | | 5.1 | 1.0 | |
| 14-20 | 93.3 | 3.0 | 3.6 | 31.5 | 32.7 |
| 20-40 | 90.0 | 2.9 | 7.0 | 54.9 | 56.6 |
| 40-60 | 80.5 | 3.1 | 16.4 | 8.8 | 10.6 |
| 60-230 | 97.4 | <1 | 2.6 | 3.6 | |
| >230 | 79.8 | <1 | 20.2 | 0.2 | |

(1) Oxygen is calculated by difference.

TABLE 3
Mercury intrusion determinations of particle densities
for the catalyst and two char fractions.

| | Bulk | Particle | Skeletal | Inorganics in char fraction | |
|---|---|---|---|---|---|
| | Density | Density | Density | Wt % | Wt % |
| Description | g/ml | g/ml | g/ml | Catalyst | Ash |
| Catalyst | 0.754 | 1.188 | 2.062 | 100 | 0 |
| 20-40 mesh | 0.189 | 0.398 | 1.369 | 26.4 | 1.45 |
| Char | | | | | |
| 40-60 mesh | 0.323 | 0.758 | 1.810 | 67.7 | 0.15 |
| Char | | | | | |

### EXAMPLE 3

Temperature Programmed Oxidation (TPO) of Char and Catalyst

A catalytic char and catalyst mixture was made by mixing a catalytic char obtained from biomass CFP in a fluidized-bed reactor in Example 2 with a fresh sample of commercial fluid bed catalyst (calcined at 550° C. for 2 h). The catalytic char was ground to a small particle size before mixing. The final mixture contained 2 wt % catalytic char and 98 wt % catalyst.

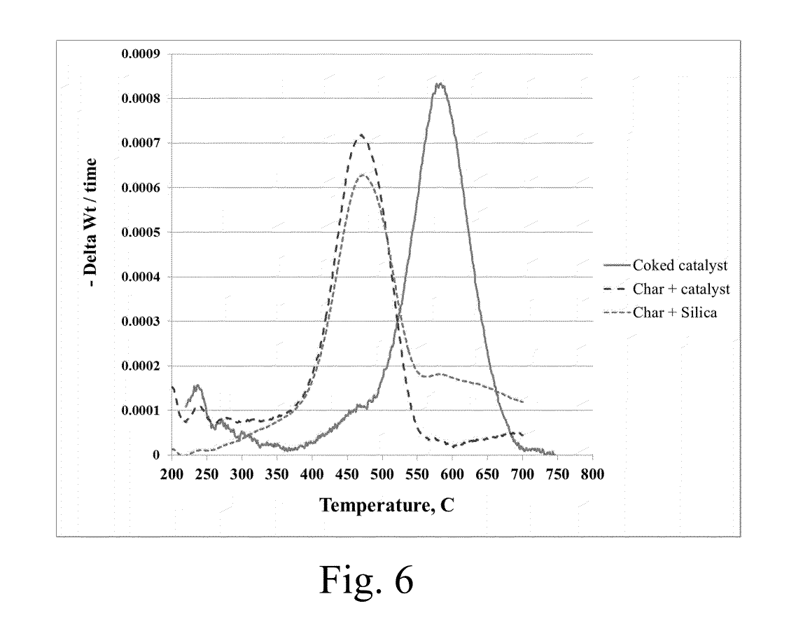

A 19.5 mg portion of the mixture was placed in a platinum pan and treated in flowing air (50 mL/min) at 120° C. for 20 min in the TGA chamber (TGA: Shimadzu TGA-50) to remove moisture. After pre-treatment, the temperature was increased to 900° C. at a ramping rate of 30° C./min under the same air flow. The weight of the sample was monitored and continuously recorded by the TGA balance. The data are presented in FIG. 6.

Temperature Programmed Oxidation (TPO) of Char and Silica

A mixture of catalytic char and silica was prepared by mixing a portion of the 20-40 mesh (850-425 microns) catalytic char obtained from biomass CFP in a fluidized-bed reactor in Example 2 and deactivated silica gel (deactivated at 800° C. in air for 10 h). The sample contained 2 wt % catalytic char and 98 wt % silica gel.

An 18.5 mg portion of the mixture was placed in a platinum pan and treated in flowing air (50 mL/min) at 120° C. for 20 min in the TGA chamber (TGA: Shimadzu TGA-50) to remove moisture. After pre-treatment, the temperature was increased from 120 C to 900 C at a ramping rate of 30 C/min under the same air flow. The weight of the sample was monitored and continuously recorded by the TGA balance. The data are presented in FIG. 6.

Temperature Programmed Oxidation (TPO) of Coked Catalyst

A coked catalyst sample was obtained directly from biomass CFP in a fluidized-bed reactor in Example 2.

An 18.5 mg portion of coked catalyst was place in a platinum pan and treated in flowing air (50 mL/min) at 120° C. for 20 min in the TGA chamber (TGA: Shimadzu TGA-50) to remove moisture. After pre-treatment, the temperature was increased from 120 C to 900 C at a ramping rate of 30 C/min under the same air flow. The weight of the sample was monitored and continuously recorded by the TGA balance. The data are presented in FIG. 6.

In FIG. 6 the data from the three TPO experiments has been normalized to give similar peak heights for the three samples, and the value of the weight changes are plotted on the Y-axis vs temperature on the X-axis. The maximum weight changes for the char-catalyst and char-silica mixtures occur at 470-473 C while the maximum weight change for the coked catalyst occurs at 584 C. The char contains about 64% carbon and 26% catalyst while coked catalyst contains about 2% carbon. Thus less than 1% of the weight loss of the 20-40 mesh (850-425 microns) char sample is due to carbon on the coked catalyst that is contained therein as determined by the relative areas under the TPO peaks centered at 470 C and 584 C.

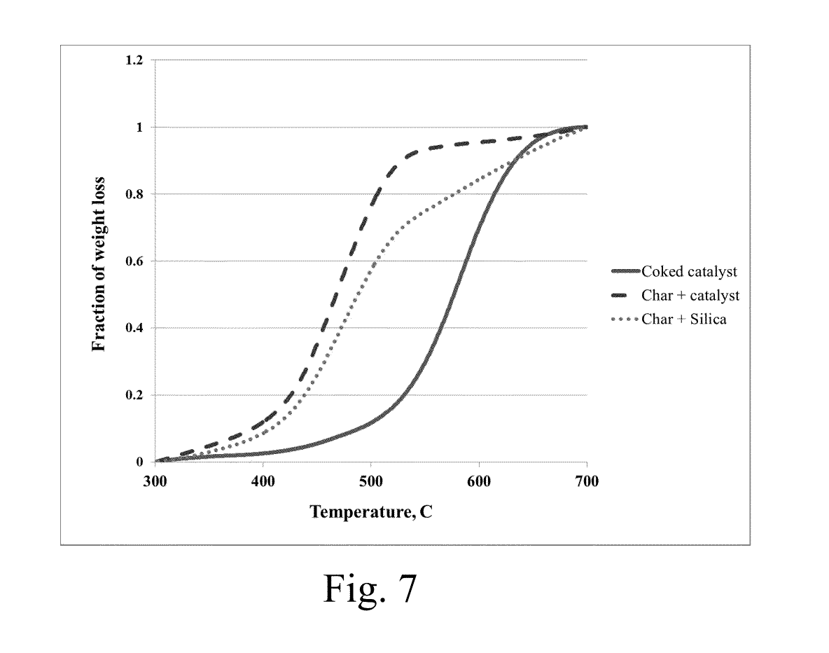

FIG. 7 shows the cumulative weight loss of the char-catalyst mixture and coked catalyst samples as a function of temperature over the range 300-700 C in the TPO experiments above. The char-catalyst mixture sample shows a greater fractional weight loss than the coked catalyst sample at all temperatures between about 350 C and 650 C. The catalyst char mixture sample shows 20% weight loss at about 426 C while the coked catalyst sample shows less than 4% weight loss at 426 C and the coked catalyst sample shows 20% weight loss at a higher temperature than the char, about 528 C in the TPO experiment. The catalyst char mixture sample shows 50% weight loss at about 468 C while the coked catalyst sample shows only about 7% weight loss at 468 C and the coked catalyst sample shows 50% weight loss at a higher temperature than the char, about 577 C in the TPO experiment. The char-catalyst sample shows about 90% weight loss at about 528 C whereas the coked catalyst sample shows only about 19% weight loss at 528 C in the TPO experiment; the coked catalyst sample shows 90% weight loss at a much higher temperature than the char, about 633 C.

The experimental data presented in FIG. 7 demonstrate that the oxidative removal of coke from a coked catalyst occurs at a much higher temperature than the oxidation of char produced in a CFP process.

### EXAMPLE 4

Electrostatic Separation of Char from a Solids Mixture

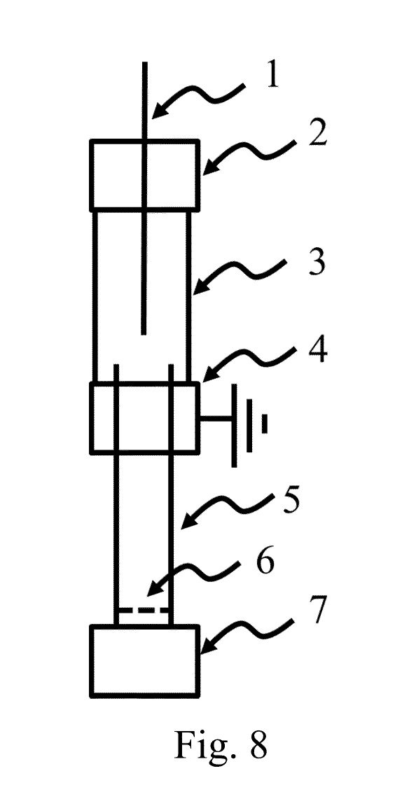

A sample of solid material from a fluidized bed CFP reaction of hardwood over ZSM-5, was separated from the solids mixture by sieving. The material retained on a 250 micron (60 mesh) size screen that comprised catalyst particles and char similar to that shown in FIG. 4, was used for this experiment. A 2.04 gram sample of this material was ground manually using a mortar and pestle until it appeared to be a fine powder and all the large particles were crushed. The sample contained 25.06% carbon. The electrostatic separation apparatus is shown in FIG. 8. A sample of the crushed material was loaded into the 12.7 mm (0.5 inch) OD polycarbonate tube (5) and held in place by a 0.5 micron frit (6) in the apparatus shown in FIG. 8. An 18.5 mm (0.75 inch) OD stainless steel collection tube (3) was attached via a rubber adapter (2) and via a stainless steel adapter (4), which was connected to ground. The copper electrode (1) was inserted into the collection tube using perforated plastic disks (not shown) to keep it centered whilst still allowing for gas flow. The high voltage supply was turned on and slowly brought up to a safe level just below the voltage that was observed to allow charge to jump from the electrode to the collection plate, about 6.4 kV.

With the electrode energized, flow of N₂ was initiated through fitting 7 and adjusted to 250 mL/min. After 30 minutes the flow was stopped and the electrode was turned off. The collection tube was carefully removed and 0.36 g of separated char was collected from the collection tube (3) and from the reducing fitting (4) below it. The 1.60 g of material remaining in the bed was collected. Analysis of the separated char indicated it contained 61.62% carbon, and the remaining solid residue contained 14.26% carbon. A separate sample of coked catalyst from a similar CFP experiment contained 1.6% carbon. The material transferred to the collector was enriched in carbon while the solid residue was depleted in carbon compared to the sample mixture.

Compositional analysis of the separated char sample and the residue was performed, and the results are collected in Table 4.

TABLE 4
Compositional analyses of unseparated char, separated char,
and residue from electrostatic separation. Values are percent
by mass of each element.

| | Mass | C | K | Ca | Si | Al |
|---|---|---|---|---|---|---|
| Sample | grams | wt % | wt % | wt % | wt % | wt % |
| Char - | 2.04 | 25.06 | 0.191 | 0.338 | 23.5 | 7.12 |
| unseparated | | | | | | |
| Separated Char | 0.36 | 61.62 | 0.257 | 0.748 | 11.7 | 3.43 |
| Residue | 1.60 | 14.26 | 0.239 | 0.219 | 26.5 | 7.79 |

The results of Example 4 show that char can be selectively separated from a catalyst/char mixture by electrostatic separation. The char separated by the electrostatic separation has been enriched in calcium and carbon, and depleted in silicon and alumina, demonstrating that at least a portion of the AAEMs are selectively removed along with the char and the residue is selectively enriched in catalyst as shown by the increased concentration of Si and Al compared to the unseparated char.

1. A method for producing aromatic chemicals or olefins, comprising:
reacting solid biomass in the presence of a catalyst in a reaction zone;
producing a product stream or product streams that exits from the reaction zone;
withdrawing a solid mixture from the reaction zone; wherein the solid mixture that is removed is separate from the product stream or streams;
separating at least a portion of char from the solid mixture prior to a catalyst regeneration step; and
recovering aromatics or olefins from the product stream.

2. The method of claim 1 wherein at least a portion of the separated char is added to the reaction zone and the separated char added to the reaction zone is not contacted with biomass prior to the reaction zone.

3. The method of claim 1 wherein aromatics are recovered from the product stream and the recovered aromatics comprise benzene, toluene, and xylenes in an amount of at least 10%, preferably at least 15% yield based on carbon in the biomass where the yield is the sum of the carbon in the benzene, toluene, and xylenes divided by the carbon in the biomass feed.

4. The method of any of the previous claims wherein the separation of the solid mixture is conducted in a cyclone or series of cyclones or by solids flotation or elutriation, preferably comprising a bubbling bed of gas and solid particles, or by a screen, a set of screens with various hole openings, or another size exclusion device where separation of solids occurs based on particle size differences or by elutriation to provide char-enriched and char-depleted streams.

5-8. (canceled)

9. The method of claim 1 wherein at least a portion of the char is comminuted before it is separated from the other solids.

10-11. (canceled)

12. The method of claim 1 wherein a portion of the char separated from the catalyst is subjected to combustion with an excess of oxygen greater than or equal to the minimum required for complete conversion of the char into carbon dioxide and water.

13. The method of claim 12 wherein heat is recovered from the combustion of the char and transferred to the catalytic biomass conversion reactor, or heat is utilized to generate steam, or heat is utilized to generate electricity, or some combination of these.

14-15. (canceled)

16. The method of claim 1 wherein the catalyst comprises a zeolite, and wherein the catalyst regeneration is operated at a temperature of less than 750 C, or less than 700 C, or less than 650 C, or less than 625 C, or from 550 C to 750 C, or from 575 C to 700 C, or from 600 C to 650 C.

17-21. (canceled)

22. The method of claim 2 wherein at least a portion of the char is chemically reacted and a portion of the reacted char is returned to the catalytic biomass reactor.

23. (canceled)

24. The method of claim 2 wherein the char is partially oxidized by reaction with ozone, oxygen, diluted air, hydrogen peroxide, peracetic acid (CH₃C(O)OOH), performic acid (HC(O)OOH), isobutyl peroxide, NO₂, NO, or other gaseous or liquid oxidizing agents.

25-27. (canceled)

28. The method of claim 1 wherein the char is treated with an acidic solution; preferably the acidic solution comprises acetic, formic, nitric, sulfuric, propionic, or carbonic acid, or a portion of the water produced in the CFP process, or combinations of these.

29. (canceled)

30. A char-based composition (char) produced by the method of claim 4.

31. A char-based composition (char) comprising at least 1 wt % zeolite or zeolite-containing catalyst and 10 to 99 wt % carbon.

32-36. (canceled)

37. The char-based composition of claim 30 wherein the sum of alkali and alkaline earth elements comprises at least 0.1%, or at least 0.2%, or at least 0.5%, or at least 1.0%, or at least 2.0% by weight of the char.

38-41. (canceled)

42. The char-based composition of claim 31 wherein the char comprises less than 0.1 wt %, or less than 0.01%, or less than 0.001 wt %, of each of V, Ni, and As.

43-44. (canceled)

45. The char-based composition of claim 31, as measured by mercury intrusion porosimetry,
has a bulk density less than 1.0 g/ml, or less than 0.75 g/ml, or less than 0.5 g/ml, or less than 0.35 g/ml, or less than 0.3 g/ml, or less than 0.2 g/ml, or from 0.05 to 1.0 g/ml, or from 0.1 to 0.75 g/ml, or from 0.18 to 0.5 g/ml,
or a particle density less than 1.5, or less than 1.1, or less than 1.0, or less than 0.9, or less than 0.8, or less than 0.7, or less than 0.6, or less than 0.5, or less than 0.4 g/ml, or from 0.1 to 1.1 g/ml, or from 0.2 to 1.0 g/ml, or from 0.3 to 0.9 g/ml, or from 0.5 to 0.7 g/ml,
or a skeletal density less than 2.0 g/ml, or less than 1.9 g/ml, or less than 1.85 g/ml, or less than 1.7 g/ml, or less than 1.55 g/ml, or less than 1.4 g/ml, or from 1.0 to 2.0 g/ml, or from 1.3 to 1.9 g/ml, or from 1.4 to 1.85 g/ml.

46. A method of amending soil comprising: providing char comprising at least 1% by weight zeolite; and mixing the char into soil.

47-48. (canceled)

49. The method of claim 12 wherein the combustion of char is conducted in a circulating fluid bed reactor, riser reactor, gasifier, counter-current gasifier, co-current gasifier, cross-draught gasifier, fluid bed gasifier, double fired gasifier, entrained bed gasifier, molten bath gasifier, heat exchange reactor, circulating loop reactor, staged combustion reactor, or any other combustion reactor.

50. The method of claim 1 wherein the heat release in the catalyst regenerator is at least 20%, or at least 33%, or at least 50%, or at least 60%, or at least 66%, or at least 75% less when the char has been removed compared to the heat release when the char and coked catalyst are combusted together in the regenerator without separation.

51. (canceled)
